(19) United States
(12) Patent Application Publication
(10) Pub. No.: US 2026/0103051 A1
(43) Pub. Date: Apr. 16, 2026

(54) IN-VEHICLE AIR CONDITIONING DEVICE

(71) Applicant: TOYOTA JIDOSHA KABUSHIKI KAISHA, Toyota-shi (JP)

(72) Inventor: Akira TSUCHIYA, Seto-shi (JP)

(73) Assignee: TOYOTA JIDOSHA KABUSHIKI KAISHA, Toyota-shi (JP)

(21) Appl. No.: 19/223,571

(22) Filed: May 30, 2025

(30) Foreign Application Priority Data
Oct. 11, 2024 (JP) 2024-178613

(51) Int. Cl. B60H 1/32

(52) U.S. Cl. CPC B60H 1/3228

(57) ABSTRACT

An in-vehicle air conditioning device includes a refrigerant circuit, a first cooling liquid circuit, a second cooling liquid circuit, a cover, and a stirring unit. The refrigerant circuit includes a compressor, a condenser for heat dissipation, an expansion valve, and an evaporator for heat absorption, and circulates the hydrocarbon-based refrigerant mixed with the odorant. The first cooling liquid circuit includes a radiator and circulates the cooling liquid heated by the condenser of the refrigerant circuit. The second cooling liquid circuit includes a cooler core for cooling an air conditioning airflow, and circulates the cooling liquid cooled by the evaporator of the refrigerant circuit. The cover covers the refrigerant circuit from below. The stirring unit is provided inside the cover, and stirs the hydrocarbon-based refrigerant and the odorant that have leaked from the refrigerant circuit.

### CROSS-REFERENCE TO RELATED APPLICATION

This application claims priority to Japanese Patent Application No. 2024-178613 filed on Oct. 11, 2024. The disclosure of the above-identified application, including the specification, drawings, and claims, is incorporated by reference herein in its entirety.

### BACKGROUND

### 1. Technical Field

The present specification relates to in-vehicle air conditioning devices. More particularly, the present specification discloses an in-vehicle air conditioning device that uses a hydrocarbon-based refrigerant containing an odorant.

### 2. Description of Related Art

In recent years, it has been considered to use hydrocarbon-based refrigerants (HC-based refrigerants) such as propane with a low global warming potential as refrigerants for air conditioning devices. Since HC-based refrigerants are flammable, configurations for preventing refrigerant leaks beforehand, configurations for ensuring safety in the event of a refrigerant leak, etc. have been considered.

HC-based refrigerants are odorless. Therefore, even if a refrigerant leak occurs, it cannot be detected by odor. Therefore, it has been proposed to add an odorant to an HC-based refrigerant for use in household refrigerators etc. to allow a refrigerant leak to be detected by odor.

Japanese Unexamined Patent Application Publication No. 2000-319647 (JP 2000-319647 A) discloses an air conditioning refrigerant containing carbon dioxide and an odorant.

### SUMMARY

An in-vehicle air conditioning device may be provided with at least two cooling liquid circuits in addition to a refrigerant circuit for a hydrocarbon-based refrigerant.

Specifically, an in-vehicle air conditioning device may be provided with a refrigerant circuit including a compressor, a condenser for heat dissipation, an expansion valve, and an evaporator for heat absorption and configured such that a hydrocarbon-based refrigerant circulates in the refrigerant circuit. An in-vehicle air conditioning device may further be provided with a first cooling liquid circuit including a radiator and configured such that a cooling liquid heated by the condenser of the refrigerant circuit circulates in the first cooling liquid circuit. An in-vehicle air conditioning device may further be provided with a second cooling liquid circuit including a cooler core for cooling an air conditioning airflow and configured such that the cooling liquid cooled by the evaporator of the refrigerant circuit circulates in the second cooling liquid circuit; With this configuration, the refrigerant circuit for the hydrocarbon-based refrigerant can be concentrated in a limited area in a vehicle body, and the refrigerant circuit can be covered with a cover. Therefore, the refrigerant circuit can be isolated from other components of the vehicle body to enhance the safety of a vehicle.

By adding an odorant to the hydrocarbon-based refrigerant used in this refrigerant circuit, it is possible to detect a refrigerant leak by odor even if the refrigerant leaks to the outside through the cover of the refrigerant circuit.

However, if the hydrocarbon-based refrigerant having leaked from the refrigerant circuit and stagnated inside the cover separates from the odorant, and the hydrocarbon-based refrigerant with a reduced concentration of the odorant leaks to the outside of the cover, the refrigerant leak may not be able to be detected by odor. Therefore, there is a demand for a technique that can reduce separation of a hydrocarbon-based refrigerant having leaked inside a cover of a refrigerant circuit from an odorant.

The present specification discloses an in-vehicle air conditioning device that can reduce separation of a hydrocarbon-based refrigerant having leaked inside a cover of a refrigerant circuit from an odorant.

An in-vehicle air conditioning device disclosed in the present specification is characterized by including:
a refrigerant circuit including a compressor, a condenser for heat dissipation, an expansion valve, and an evaporator for heat absorption and configured such that a hydrocarbon-based refrigerant mixed with an odorant circulates in the refrigerant circuit;
a first cooling liquid circuit including a radiator and configured such that a cooling liquid heated by the condenser of the refrigerant circuit circulates in the first cooling liquid circuit;
a second cooling liquid circuit including a cooler core configured to cool an air conditioning airflow, and configured such that the cooling liquid cooled by the evaporator of the refrigerant circuit circulates in the second cooling liquid circuit;
a cover covering the refrigerant circuit from below; and
a stirring unit provided inside the cover and configured to stir the hydrocarbon-based refrigerant and the odorant that have leaked from the refrigerant circuit.

With this configuration, the hydrocarbon-based refrigerant and the odorant that have leaked inside the cover are stirred. This can reduce separation of the hydrocarbon-based refrigerant from the odorant, and can reduce leakage of hydrocarbon-based refrigerant with a reduced concentration of the odorant to the outside of the cover.

In the in-vehicle air conditioning device of the present disclosure,
the stirring unit may include
a rotating body configured to rotate inside the cover to cause the hydrocarbon-based refrigerant and the odorant inside the cover to flow, and
a motor configured to drive the rotating body.

In this configuration, the rotating body is driven by the motor. Therefore, the rotating body causes the hydrocarbon-based refrigerant and the odorant to flow, which can reduce separation of the hydrocarbon-based refrigerant from the odorant.

In the in-vehicle air conditioning device of the present disclosure,
the rotating body may be provided at the bottom of the cover or a side wall of the cover so as to mix the hydrocarbon-based refrigerant and the odorant that stagnate at the bottom of the cover.

The hydrocarbon-based refrigerant and the odorant are generally heavier than air. Therefore, they stagnate at the bottom of the cover. In the above configuration, the rotating body is provided at the bottom or side wall of the cover. Therefore, the rotating body causes the hydrocarbon-based refrigerant and the odorant that stagnate at the bottom of the cover to flow, which can reduce separation of the hydrocarbon-based refrigerant from the odorant.

The in-vehicle air conditioning device of the present disclosure may further include:
a controller configured to control the stirring unit; and
a gas sensor provided inside the cover and configured to detect the hydrocarbon-based refrigerant.
The controller may be configured to drive the stirring unit when the hydrocarbon-based refrigerant is detected by the gas sensor.

In this configuration, the stirring unit is driven when the hydrocarbon-based refrigerant inside the cover is detected by the gas sensor. Therefore, the stirring unit does not have to be driven in a normal state in which there is no leakage of the hydrocarbon-based refrigerant from the refrigerant circuit.

In the in-vehicle air conditioning device of the present disclosure, the stirring unit may include a moving body configured to roll and move at the bottom of the cover due to inertial force when a vehicle accelerates or decelerates.

In this configuration, the moving body configured to roll and move causes the hydrocarbon-based refrigerant and the odorant to flow, which can reduce separation of the hydrocarbon-based refrigerant from the odorant.

In the in-vehicle air conditioning device of the present disclosure, the hydrocarbon-based refrigerant may be propane or a refrigerant mainly containing propane.

A vehicle disclosed in the present specification includes the in-vehicle air conditioning device described above.

The technique disclosed in the present specification can reduce separation of a hydrocarbon-based refrigerant having leaked inside a cover of a refrigerant circuit from an odorant.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic diagram illustrating a configuration of an air conditioning device;

FIG. 2 is an exploded perspective view of a cover of a refrigerant module;

FIG. 3 is a perspective view showing a refrigerant module housed in a cover body;

FIG. 4 is a cross-sectional view of a cover showing a fan and motor as a stirring unit;

FIG. 5 is a cross-sectional view of a cover showing a spherical body as another stirring unit;

FIG. 6 is a cross-sectional view showing a cross-section of the cover, showing a plate member as a further stirring unit; and

FIG. 7 is a diagram for explaining a stirring unit provided inside a receiver or an accumulator.

### DETAILED DESCRIPTION OF EMBODIMENTS

### Introduction

Hereinafter, embodiments will be described with reference to the drawings. In all the drawings, equivalent elements are denoted by the same reference numerals, and redundant description is omitted. In the following description, unless otherwise specified, the terms indicating the front-rear, right-left, and up-down, etc. directions indicate the directions related to a vehicle. In each figure, the direction of the arrow FR indicates a forward direction, the direction of the arrow UP indicates an upward direction, and the direction of the arrow LH indicates a leftward direction.

The air conditioning device is mounted on a vehicle such as an automobile. In the embodiments described below, the type of the vehicle on which the air conditioning device is mounted is not limited. For example, the vehicle may be an engine vehicle using an engine as a power source, or a battery electric vehicle using a motor as a power source. The vehicle may be a hybrid battery electric vehicle or a plug-in hybrid battery electric vehicle equipped with both an engine and a motor. The vehicle may be a fuel cell electric vehicle equipped with fuel cells, or may be a battery electric vehicle that runs with electric power stored in a battery.

The air conditioning device includes a refrigerant circuit in which a hydrocarbon-based refrigerant (referred to as HC-based refrigerant) circulates. HC-based refrigerants are flammable. Examples of the HC-based refrigerant include propane, butane, isobutane, ethane, ethylene, and propylene. In the refrigerant circuit, a refrigerant obtained by mixing one of HC-based refrigerants or two or more of HC-based refrigerants may be used. In the refrigerant circuit, a mixed refrigerant mainly containing one or more kinds of HC-based refrigerants and further containing a refrigerant other than HC type refrigerants, various additives, etc. may be used. For example, in the refrigerant circuit, propane or a refrigerant mainly containing propane and further containing at least one of another refrigerant and an additive (refrigerant mainly containing propane) may be used. HC-based refrigerant may be R290 as an example. In the present specification, the hydrocarbon-based refrigerant (HC-based refrigerant) means a pure hydrocarbon-based refrigerant or a refrigerant mainly containing a hydrocarbon-based refrigerant.

The hydrocarbon-based refrigerant may be mixed (added) with an odorant (also referred to as an odorant). The odorant may include, for example, a sulfur compound such as mercaptans and sulfides. The components of the odorant are not limited.

The refrigerant circuit serves as a heat source of the air conditioning device. The refrigerant circuit includes, in order along the flow direction of the refrigerant, a compressor, a condenser for heat dissipation, an expansion valve, and an evaporator for heat absorption. A receiver may be provided between the condenser and the expansion valve. An accumulator may be provided between the evaporator and the compressor.

The air conditioning device may include a high-temperature cooling liquid circuit in which the cooling liquid heated by the condenser of the refrigerant circuit circulates, and a low-temperature cooling liquid circuit in which the cooling liquid cooled by the evaporator of the refrigerant circuit circulates. The cooling liquid is a heat medium, and the high-temperature cooling liquid circuit and the low-temperature cooling liquid circuit are each a heat medium circuit.

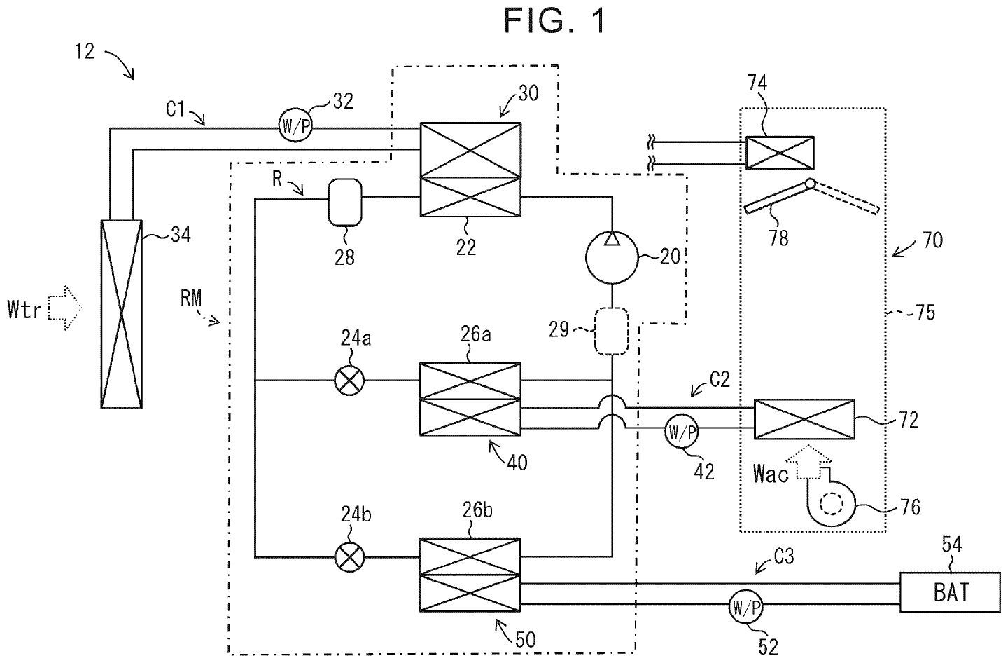

In the embodiment described below, as shown in FIG. 1, the air conditioning device 12 includes a first cooling liquid circuit C1 as a high-temperature cooling liquid circuit and second and third cooling liquid circuits C2, C3 as a low-temperature cooling liquid circuit.

The cooling liquid in the first to third cooling liquid circuits C1, C2, C3 may be coolant. That is, the cooling liquid may be water containing no additive, water containing an additive such as an antifreeze agent or an antiseptic, or a coolant liquid. Further, a liquid heat medium such as oil may be employed as the cooling liquid, and is not limited thereto.

In the embodiments described below, the refrigerant circuit is located below the front hood of the vehicle. Hereinafter, the area under the front hood is referred to as an “engine compartment” regardless of the presence or absence of a power source (an engine, a motor, etc.) under the front hood and the type of the power source.

### Embodiments

FIG. 1 is a schematic diagram illustrating a configuration of an air conditioning device 12 according to an embodiment. The air conditioning device 12 is mounted on an electrified vehicle. The electrified vehicle may be a vehicle equipped with a battery 54 for supplying electric power to a motor as a power source, for example, a battery electric vehicle, a hybrid battery electric vehicle, a plug-in hybrid battery electric vehicle, or the like.

The air conditioning device 12 performs air conditioning of the interior of the vehicle and cooling of the battery 54. Note that the air conditioning device 12 may be configured to cool an in-vehicle device such as a PCU (Power Control Unit) together with the battery 54 or instead of the battery 54.

As shown in FIG. 1, the air conditioning device 12 includes a refrigerant circuit R serving as a heat source, first to third cooling liquid circuits C1, C2, C3, and an air conditioning unit 70. In the first cooling liquid circuit C1, the first cooling liquid heated by the refrigerant in the refrigerant circuit R circulates. In the second cooling liquid circuit C2, the second cooling liquid cooled by the refrigerant in the refrigerant circuit R circulates. Similarly, in the third cooling liquid circuit C3, the third cooling liquid cooled by the refrigerant in the refrigerant circuit R circulates. The air conditioning unit 70 supplies the air cooled by the second cooling liquid circulating in the second cooling liquid circuit C2 to the vehicle cabin.

The refrigerant circuit R is a closed circuit in which the compressor 20, the condenser 22, the receiver 28, the expansion valves 24a, 24b, and the evaporators 26a, 26b are connected to each other by a refrigerant pipe in order to circulate an HC-based refrigerant (hereinafter, also simply referred to as a refrigerant). An accumulator 29 (indicated by a broken line in FIG. 1) may be provided between the evaporators 26a, 26b and the compressor 20. The expansion valve 24a and the evaporator 26a are connected in series, and similarly the expansion valve 24b and the evaporator 26b are connected in series. The expansion valve 24a, the refrigerant channel of the evaporator 26a, and the refrigerant channel of the expansion valve 24b and the evaporator 26b are connected in parallel.

An odorant is mixed with the refrigerant of the refrigerant circuit R. Therefore, when the refrigerant leaks from the refrigerant circuit R, a person can sense the refrigerant leak by the odor of the refrigerant.

The air conditioning device 12 includes a heat exchanger 30. The heat exchanger 30 is integrally formed with the condenser 22 of the refrigerant circuit R, and exchanges heat between the refrigerant of the refrigerant circuit R and the first cooling liquid of the first cooling liquid circuit C1. The heat exchanger 30 is a water-cooled condenser, and may be, for example, a plate heat exchanger.

The first cooling liquid circuit C1 is a closed circuit in which the water pump 32, the heat exchanger 30, and the radiator 34 are sequentially connected by cooling liquid pipes to circulate the first cooling liquid. The radiator 34 is a heat exchanger that exchanges heat between the first cooling liquid and the vehicle traveling wind Wtr. In the first cooling liquid circuit C1, the first cooling liquid pumped by the water pump 32 is heated to a high temperature by the heat dissipation of the refrigerant in the condenser 22 in the refrigerant circuit R while passing through the heat exchanger 30. The high-temperature first cooling liquid is sent to the radiator 34, where it is cooled by the vehicle traveling wind Wtr.

Further, the air conditioning device 12 includes a heat exchanger 40. The heat exchanger 40 is integrally formed with the evaporator 26a of the refrigerant circuit R, and exchanges heat between the refrigerant of the refrigerant circuit R and the second cooling liquid of the second cooling liquid circuit C2. The heat exchanger 40 may be, for example, a plate heat exchanger.

The second cooling liquid circuit C2 is a closed circuit in which the water pump 42, the heat exchanger 40, and the cooler core 72 are sequentially connected by cooling liquid pipes to circulate the second cooling liquid. The cooler core 72 is a heat exchanger that is disposed in the air passage 75 of the air conditioning unit 70 and exchanges heat between the second cooling liquid and the air conditioning airflow Wac. In the second cooling liquid circuit C2, the second cooling liquid pumped by the water pump 42 becomes a low temperature due to the heat absorption of the refrigerant at the evaporator 26a in the refrigerant circuit R while passing through the heat exchanger 40. The second cooling liquid having reached the low temperature is sent to the cooler core 72, where it cools the air conditioning airflow Wac.

Further, the air conditioning device 12 includes a heat exchanger 50. The heat exchanger 50 is integrally formed with the evaporator 26b of the refrigerant circuit R, and exchanges heat between the refrigerant of the refrigerant circuit R and the third cooling liquid of the third cooling liquid circuit C3. The heat exchanger 50 may be, for example, a plate heat exchanger.

The third cooling liquid circuit C3 is a closed circuit in which the water pump 52, the heat exchanger 50, and the battery 54 are sequentially connected by cooling liquid pipes to circulate the third cooling liquid. In the third cooling liquid circuit C3, the cooling liquid pumped by the water pump 52 becomes a low temperature due to the heat absorption of the refrigerant at the evaporator 26b in the refrigerant circuit R while passing through the heat exchanger 50. The third cooling liquid having reached the low temperature is sent to the battery 54 to cool the battery 54.

In the refrigerant circuit R, the refrigerant circulates as follows. The compressor 20 discharges a high-pressure gas refrigerant, the gas refrigerant is liquefied condensed by heat exchange with the first cooling liquid of the first cooling liquid circuit C1 passing through the heat exchanger 30 in the condenser 22, and becomes a high-pressure liquid refrigerant. The high-pressure liquid refrigerant flowing out of the condenser 22 is decompressed and expanded by the expansion valve 24a via the receiver 28, becomes a low-pressure refrigerant, and flows into the evaporator 26a. The low-pressure refrigerant flowing into the evaporator 26a is evaporated by heat exchange with the second cooling liquid in the second cooling liquid circuit C2 passing through the heat exchanger 40 at the evaporator 26a, becomes a gaseous refrigerant, flows out the evaporator 26a, and returns to the compressor 20.

The high-pressure liquid refrigerant flowing out of the condenser 22 is decompressed and expanded by the expansion valve 24b via the receiver 28, becomes a low-pressure refrigerant, and flows into the evaporator 26b. The low-pressure refrigerant flowing into the evaporator 26b is evaporated by heat exchange with the third cooling liquid in the third cooling liquid circuit C3 passing through the heat exchanger 50 at the evaporator 26b, becomes a gaseous refrigerant, flows out of the evaporator 26b, and returns to the compressor 20.

The air conditioning unit 70 includes a blower 76 and an air passage 75 formed by a case (not shown). In the air passage 75, a blower 76, a cooler core 72, and a heater core 74 are arranged in this order from the air flow direction. The heater core 74 is, for example, a heat exchanger to which engine coolant or coolant warmed by a water-heating PTC heater is supplied. The heater core 74 may be configured to supply the cooling liquid warmed by the heat exchanger 30.

The blower 76 introduces air into the air passage 75 from an intake port (not shown) and allows the air to be passed through the cooler core 72 and the heater core 74, thereby blowing the temperature-controlled air into the vehicle cabin. An air mix door 78 is provided inside the air passage 75, and the air mix door 78 adjusts a ratio at which the air that has passed through the cooler core 72 flows to the heater core 74. Note that the air conditioning unit 70 may employ a conventional technique of HVAC (Heating, Ventilation, and Air Conditioning).

The air conditioning unit 70 is disposed between the instrument panel and the dashboard in, for example, a vehicle. The battery 54 is disposed, for example, under the floor of the vehicle cabin, that is, under the floor panel.

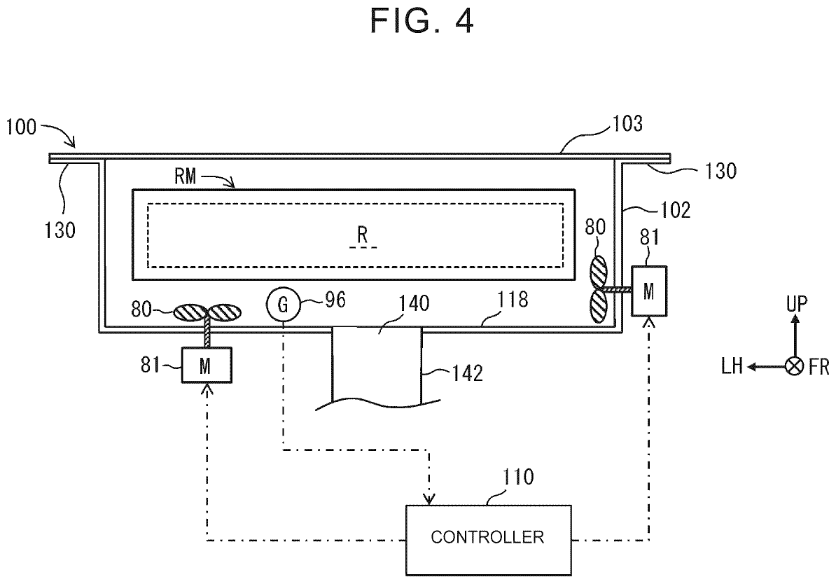

The air conditioning device 12 includes a controller. The controllers may be configured to include a processor and a storage device, e.g., an ECU (Electronic Control Unit). The controller controls the equipment included in the air conditioning device 12 based on detection information of a plurality of sensors (outside air temperature, inside air temperature, temperature of the battery (temperature of the battery 54)), a solar radiation amount sensor, a pressure sensor (sensor for detecting pressure in a pipe), and the like), setting information of an operation panel operated by a user, and the like. The controller may employ a conventional control technique of an air conditioning device. This controller may be the same as or different from the controller 110 shown in FIG. 4 described later.

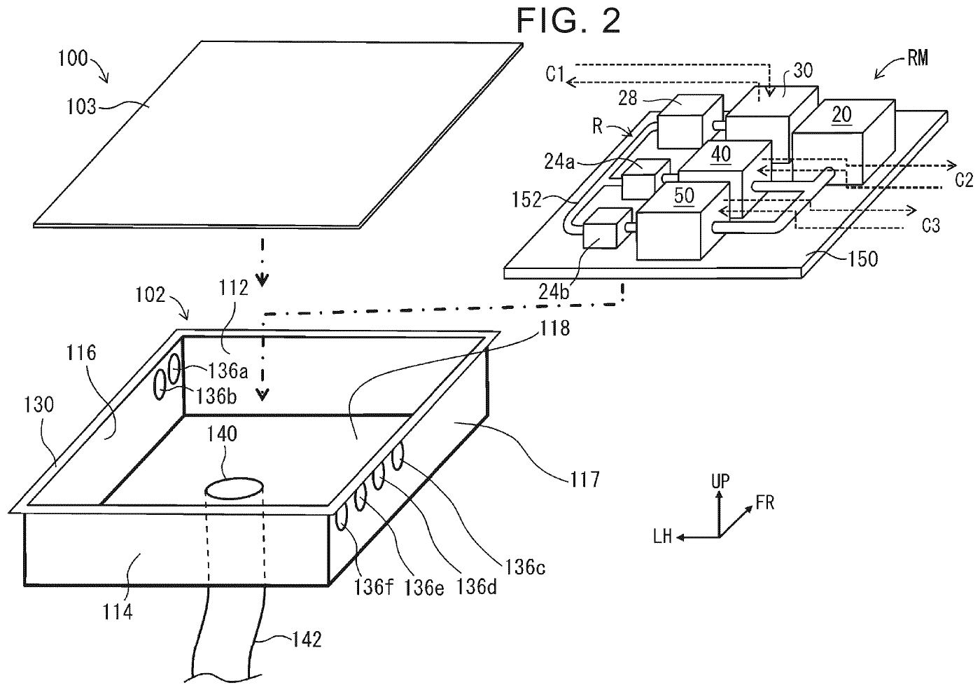

As shown in the upper right of FIG. 2, the refrigerant circuit R is integrated to form a refrigerant module RM. Specifically, the refrigerant module RM is a unit of the air conditioning device 12 in which the devices (components) inside the long dashed short dashed line in FIG. 1 are integrated. In the refrigerant module RM, as shown in FIG. 2, the compressor 20, the first to third heat exchangers 30, 40, 50, the receiver 28, and the two expansion valves 24a, 24b are fixed to the upper surface of the plate 150 by screws or the like. The devices are connected to each other by a refrigerant pipe 152.

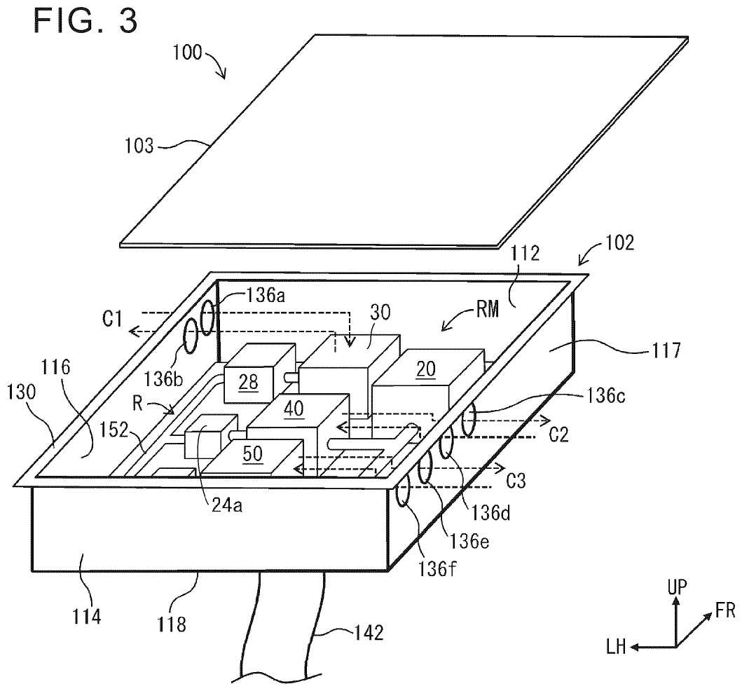

As shown in FIG. 2, the air conditioning device 12 includes a cover 100. The cover 100 includes a cover body 102 and a top panel 103. As shown in FIG. 3, the refrigerant module RM is housed in the cover body 102. The refrigerant module RM is fixed to the inner surface of the cover body 102 via brackets (not shown). The top panel 103 is attached to the cover body 102 so as to cover the cover body 102 in which the refrigerant module RM is accommodated.

The cover 100 and the refrigerant module RM are arranged in the engine compartment of the vehicle. The cover 100 is disposed, for example, behind a front end of a drive unit (an engine unit, a motor unit, a power train unit including an engine and a transaxle, an e-axle, or the like) and above the drive unit.

The cover body 102 includes an outer surface having heat shielding properties. The heat shielding property may be obtained by forming the cover body 102 itself with a heat shielding material, or may be obtained by providing aluminum vapor deposition, aluminum foil, or the like on the outer surface of the cover body 102. As shown in FIG. 2, the cover body 102 includes a front wall 112, a rear wall 114, a left side wall 116, a right side wall 117, and a bottom wall 118. The outer surfaces of these walls have a thermal barrier property. The cover body 102 also includes an outwardly projecting flange 130 at its upper end. The flange 130 has a frame shape in a top view.

As shown in FIG. 3, the left side wall 116 has two through holes 136a, 136b through which the pipes of the first cooling liquid circuit C1 pass. The right side wall 117 has two through holes 136c, 136d through which the pipes of the second cooling liquid circuit C2 pass, and two through holes 136e, 136f through which the pipes of the third cooling liquid circuit C3 pass. Note that one or more walls of the cover body 102 may have holes (not shown) through which electric wires such as a power line and a control line connected to equipment such as the compressor 20 pass.

As shown in FIG. 2, the bottom wall 118 of the cover body 102 includes a hole 140. A hose 142 extending downward of the vehicle is connected to the hole 140. The hose 142 extends from the hole 140 of the bottom wall 118 toward the bottom of the vehicle body. A distal end (not shown) of the hose 142 may be secured to a vehicle body structure located at a lower portion (or bottom) of the engine compartment.

By the hose 142, when HC-based refrigerant leaks from the refrigerant circuit R into the cover 100, HC-based refrigerant can be guided to the lower part of the vehicle through the hose 142. The HC-based refrigerant is generally heavier than air, and therefore flows downward through the hose 142. This allows the HC-based refrigerant to be discharged to a relatively safe location at the bottom of the vehicle body.

The top panel 103 also includes an outer surface having a heat shielding property. The heat shielding property may be obtained by forming the top panel 103 itself with a heat shielding material, or may be obtained by providing aluminum vapor deposition, aluminum foil, or the like on the outer surface of the top panel 103. The top panel 103 is disposed on the flange 130 of the cover body 102. The outer peripheral portion of the top panel 103 is fastened to the flange 130 of the cover body 102 by a plurality of screws.

According to this embodiment, the refrigerant circuit R of HC-based refrigerant can be concentrated in a limited area in the vehicle body, and the refrigerant circuit R can be covered with the cover 100. Therefore, the refrigerant circuit R can be isolated from other elements of the vehicle body to improve the safety of the vehicle.

Note that the cover 100 may be configured without the top panel 103. The top panel 103 may have an opening. In addition, the cover 100 may have no heat shielding property. The whole or a part of the cover 100 may be made of metal, resin, or the like.

Further, another air conditioning device may be configured by omitting the expansion valve 24b, the heat exchanger 50, and the third cooling liquid circuit C3 from the air conditioning device 12 (see FIG. 1). The air conditioning device can be employed in a vehicle such as an engine vehicle that does not have a battery 54 (a battery that supplies electric power to a motor).

Further, the refrigerant circuit R may not be fixed to the plate 150 (FIG. 2) as described above. That is, the refrigerant circuit R only needs to be housed in the cover 100. For example, the plurality of devices constituting the refrigerant circuit R may be individually fixed to the inner surface of the cover 100.

### Stirring Unit

FIG. 4 is a cross-sectional view of the cover 100. The air conditioning device 12 includes a fan 80 and a motor 81 as a stirring unit. Although two sets of fans 80 and motors 81 are shown in FIG. 4, the air conditioning device 12 may include one set or three or more sets of fans 80 and motors 81.

The fan 80 is a rotating body and is provided inside the cover 100. A fan rotation shaft for rotating the fan 80 passes through a hole portion of a wall of the cover body 102 and is connected to a drive shaft of a motor 81 provided outside the cover body 102. As shown in FIG. 4, the fan 80 may be provided at the bottom of the cover body 102. Alternatively, as shown in the figure, the fan 80 may be provided on a side wall (inner wall) of the cover body 102 located near the bottom of the cover body 102.

The air conditioning device 12 includes a gas sensor 96 and a controller 110. The gas sensor 96 is provided in the cover 100 and detects the HC-based refrigerant. The gas sensor 96 is provided, for example, at a position close to the bottom of the cover body 102. The controller 110 includes a processor and a storage device, and controls the motor 81. A detection signal of the gas sensor 96 is input to the controller 110.

When the HC-based refrigerant is detected by the gas sensor 96, the controller 110 turns on (drives) the motor 81 to rotate the fan 80. The controller 110 turns off the motor 81 and stops the fan 80 at a timing when the HC-based refrigerant is no longer detected by the gas sensor 96. It should be noted that the controller 110 may turn off the motor 81 and stop the fan 80 at a timing when a predetermined period of time has elapsed after the HC-based refrigerant is no longer detected by the gas sensor 96.

According to this embodiment, when HC-based refrigerant leaks from the refrigerant circuit R into the cover 100, since HC-based refrigerant and the odorant are stirred by the fan 80, it is possible to suppress HC-based refrigerant from separating from the odorant. It is possible to reduce leakage of the HC-based refrigerant having a reduced concentration of the odorant to the outside of the cover 100. Therefore, a person can sense a refrigerant leak by the odor of the refrigerant.

Because HC-based refrigerants and odorants are generally heavier than the atmosphere, they stagnate at the bottom of the cover 100. According to this embodiment, since the fan 80 is provided on the bottom or the side wall of the cover 100, the HC-based refrigerant and the odorant that stagnate at the bottom of the cover 100 can be caused to flow, which can reduce separation of the HC-based refrigerant from the odorant.

In addition, the controller 110 rotates the fan 80 when the HC-based refrigerant is detected by the gas sensor 96, and therefore, the fan 80 does not have to be rotated in a normal state in which there is no leak of the HC-based refrigerant from the refrigerant circuit R. Thus, the amount of electric energy consumed by the motor 81 can be reduced.

The controller 110 may turn on the motor 81 and rotate the fan 80 while the compressor 20 of the refrigerant circuit R is operating. That is, the controller 110 may rotate the fan 80 in conjunction with the operation of the compressor 20. When the compressor 20 of the refrigerant circuit R is not operating, the controller 110 turns off the motor 81 to stop the fan 80.

In addition, the controller 110 may switch the motor 81 on and off at a predetermined cycle. That is, the controller 110 may periodically turn on the motor 81 to rotate the fan 80.

### Another Stirring Unit

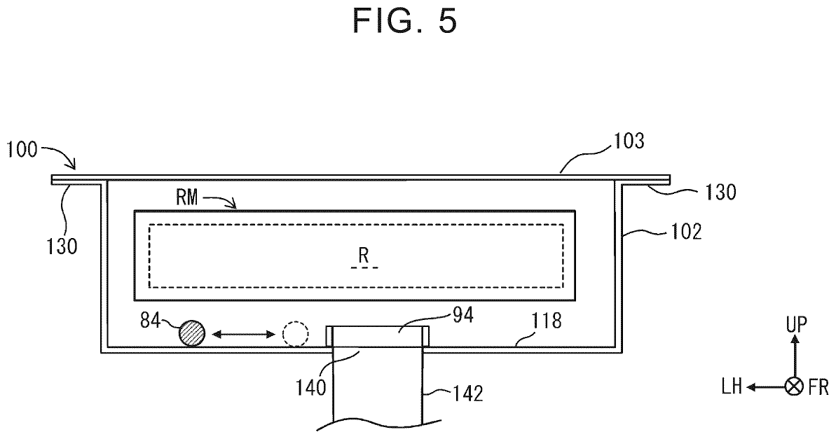

FIG. 5 shows a spherical body 84 as a further stirring unit. In this embodiment, in order to stir the HC-based refrigerant and the odorant, instead of the fan 80 and the motor 81, a spherical body 84 as a moving body is used.

The spherical body 84 is housed in the bottom of the cover body 102. The number of spherical bodies 84 may be one or may be two or more. The spherical body 84 rolls and moves at the bottom of the cover body 102 by inertial force when the vehicle accelerates or decelerates. In order to prevent the spherical body 84 from falling into the hole 140 of the cover body 102, a stopper 94, which is a wall protruding upward from an edge portion of the hole 140, is provided. According to this embodiment, the spherical body 84 causes the HC-based refrigerant and the odorant to flow, which reduces separation of the HC-based refrigerant from the odorant.

Although a simple spherical body 84 is illustrated in FIG. 5, irregularities may be added to the surface of the spherical body 84. Alternatively, the spherical body 84 may be hollow, and a part of the surface of the spherical body 84 may be cut out. That is, the shape of the spherical body 84 may be changed, or a component may be added to the surface to enhance the stirring effect associated with the rotation of the spherical body 84. The moving body is not limited to the spherical body 84, and may be any object that can roll and move when the vehicle accelerates or decelerates. The moving body may be, for example, a cylindrical or cylindrical object.

### Still Another Stirring Unit

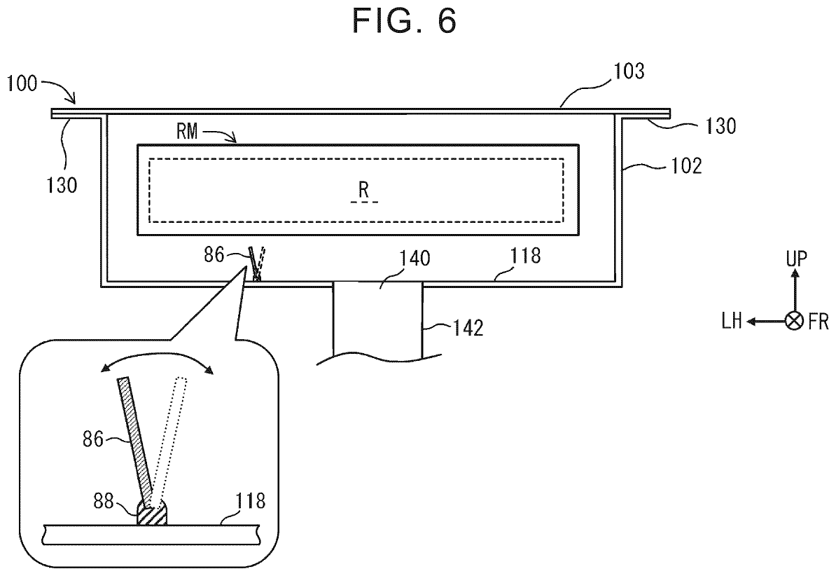

FIG. 6 shows a plate member 86 as a further stirring unit. In the figure, the plate member 86 is shown in an enlarged manner by blowing. In the embodiment shown in this drawing, in order to stir the HC-based refrigerant and the odorant, instead of the fan 80 and the motor 81, a plate member 86 is used.

A plate member 86 is swingably provided at the bottom of the cover body 102. The number of plate members 86 may be one or may be two or more. A fulcrum 88 is provided at the bottom of the cover body 102. An end portion of the plate member 86 is swingably attached to the fulcrum 88. For example, the fulcrum 88 may be formed of two shaft members fixed to the bottom of the cover body 102, and two shaft members may be inserted into the holes at the ends of the plate member 86 so that the plate member 86 can swing. In this case, a rotatable disk may be provided between the two shaft members and the bottom of the cover body 102, and the two shaft members may be configured to rotate with respect to the bottom of the cover body 102.

Alternatively, the fulcrum 88 may be composed of a hemispherical outer shell fixed to the bottom of the cover body 102 and a spherical body inserted into the outer shell. The plate member 86 may be swingable in the front, rear, left, and right directions or in any direction by providing a window in the upper portion of the outer shell and connecting the plate member 86 and the spherical body in the outer shell through the window.

The plate member 86 swings at the bottom of the cover body 102 due to inertial force when the vehicle accelerates or decelerates. As a result, the HC-based refrigerant and the odorant can be caused to flow, and separation of them can be suppressed.

### Other Embodiments

In the embodiment described above, the refrigerant module RM is housed in the cover 100, and a stirring unit for stirring the HC-based refrigerant and the odorant is provided in the cover 100. However, a stirring unit for stirring the HC-based refrigerant and the odorant may be provided inside the receiver 28 or the accumulator 29 of the refrigerant circuit R. In this case, the refrigerant circuit R may or may not be housed inside the cover 100.

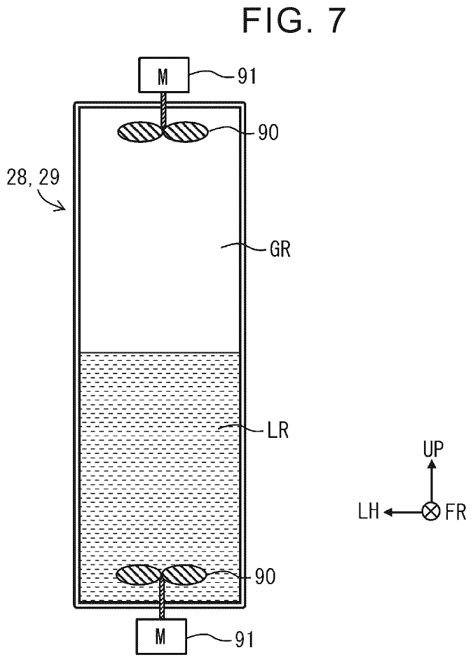

FIG. 7 is a cross-sectional view schematically showing the receiver 28 or the accumulator 29, in which a structure such as an internal pipe is omitted. Although the receiver 28 is described below as an example, the same configuration can be applied to the accumulator 29.

The air conditioning device 12 includes a fan 90 and a motor 91 as a stirring unit. Although two sets of fans 90 and motors 91 are shown in FIG. 7, the air conditioning device 12 may include one set or three or more sets of fans 90 and motors 91.

The fan 90 is a rotating body and is provided inside the receiver 28. A fan rotation shaft for rotating the fan 90 passes through a hole in the wall of the receiver 28 and is connected to a drive shaft of a motor 91 provided outside the receiver 28. The fan 90 may be provided on the top of the receiver 28 to stir the gaseous refrigerant GR in the receiver 28, as shown in FIG. 7. Alternatively, the fan 90 may be provided at the bottom of the receiver 28 to stir the liquid refrigerant LR in the receiver 28, as shown. The fan 90 may be provided on the side wall (inner wall) of the receiver 28.

The air conditioning device 12 includes a controller (not shown) configured to include a processor and a storage device. The controller controls the motor 91. For example, the controller turns on the motor 91 to rotate the fan 90 while the compressor 20 of the refrigerant circuit R is operating. Alternatively, the controller may switch the motor 91 on and off at predetermined intervals. That is, the controller may periodically turn on the motor 91 to rotate the fan 90.

According to this embodiment, in the receiver 28, since HC-based refrigerant and the odorant are stirred by the fan 90, it is possible to suppress HC-based refrigerant from separating from the odorant. When the HC-based refrigerant leaks from the refrigerant circuit R, the HC-based refrigerant with a reduced concentration of the odorant is less likely to leak to the outside of the refrigerant circuit R. Therefore, a person can sense a refrigerant leak by the odor of the refrigerant.

Instead of the fan 90 and the motor 91, the stirring unit in the receiver 28 may be the spherical body 84 (moving body) described with reference to FIG. 5 or the plate member 86 described with reference to FIG. 6. The fulcrum 88 of the plate member 86 may be provided on the ceiling of the receiver 28.

What is claimed is:

1. An in-vehicle air conditioning device comprising:
a refrigerant circuit including a compressor, a condenser for heat dissipation, an expansion valve, and an evaporator for heat absorption, the refrigerant circuit being configured such that a hydrocarbon-based refrigerant mixed with an odorant circulates in the refrigerant circuit;
a first cooling liquid circuit including a radiator, the first cooling liquid circuit being configured such that a cooling liquid heated by the condenser of the refrigerant circuit circulates in the first cooling liquid circuit;
a second cooling liquid circuit including a cooler core configured to cool an air conditioning airflow, the second cooling liquid circuit being configured such that the cooling liquid cooled by the evaporator of the refrigerant circuit circulates in the second cooling liquid circuit;
a cover covering the refrigerant circuit from below; and
a stirring unit provided inside the cover, the stirring unit being configured to stir the hydrocarbon-based refrigerant and the odorant that have leaked from the refrigerant circuit.

2. The in-vehicle air conditioning device according to claim 1, wherein the stirring unit includes
a rotating body configured to rotate inside the cover to cause the hydrocarbon-based refrigerant and the odorant inside the cover to flow, and
a motor configured to drive the rotating body.

3. The in-vehicle air conditioning device according to claim 2, wherein the rotating body is provided at a bottom of the cover or a side wall of the cover so as to mix the hydrocarbon-based refrigerant and the odorant that stagnate at the bottom of the cover.

4. The in-vehicle air conditioning device according to claim 1, further comprising:
a controller configured to control the stirring unit; and
a gas sensor provided inside the cover, the gas sensor being configured to detect the hydrocarbon-based refrigerant,
wherein the controller is configured to drive the stirring unit when the hydrocarbon-based refrigerant is detected by the gas sensor.

5. The in-vehicle air conditioning device according to claim 1, wherein the stirring unit includes a moving body configured to roll and move at a bottom of the cover due to inertial force when a vehicle accelerates or decelerates.
